(19) United States
(12) Patent Application Publication
(10) Pub. No.: US 2013/0204169 A1
(43) Pub. Date: Aug. 8, 2013

(54) Pain Management Device and System

(71) Applicant: Endetek, Inc., Pittsburgh, PA (US)

(72) Inventors: James O. Poepperling, Waverly, PA (US); Joseph A. Russo, Pittsburgh, PA (US); Richard J. Mascara, Bethel Park, PA (US)

(73) Assignee: Endetek, Inc., Pittsburgh, PA (US)

(21) Appl. No.: 13/746,772

(22) Filed: Jan. 22, 2013

Related U.S. Application Data
(60) Provisional application No. 61/588,913, filed on Jan. 20, 2012.

(51) Int. Cl. A61H 23/02

(52) U.S. Cl. CPC A61H 23/02
USPC 601/46

(57) ABSTRACT

A vibration device for providing a vibration sensation to a user, the device including: a base; a vibrating element; a power source; and, an actuation mechanism configured to facilitate an electrical connection between the power source and vibrating element, thereby causing the vibrating element to vibrate. A system for providing a vibrating sensation to a user for pain management and a method of manufacturing a vibration device for providing a vibrating sensation to a user are also disclosed.

### CROSS REFERENCE TO RELATED APPLICATION

This application is based on U.S. Provisional Patent Application No. 61/588,913 filed on Jan. 20, 2012, on which priority of this patent application is based and which is hereby incorporated by reference in its entirety.

### BACKGROUND OF THE INVENTION

1. Field of the Invention

The present invention is generally directed to a medical device for providing vibration therapy to a user for pain management and improved wound healing, decreasing inflammation and/or edema, and, more particularly, to a pad or compression sleeve which provides vibration alone or in combination with additional electrical components including, but not limited to, electrical simulation, iontophoresis, physiological monitoring, compression, or hot/cold therapies.

2. Description of the Related Art

Medical professionals rely on numerous treatment options for managing patients' pain and encouraging wound healing following surgery and traumatic injury, or as treatment for chronic conditions and persistent pain. The most common treatment option is medication. Pain reducing medications, in combination with muscle relaxants, tranquilizers, and steroids, are commonly prescribed for patients as part of a pain reduction regimen. However, prolonged use of medication is known to have adverse medical side effects, which often require patients to stop taking medication, or to continually increase the amount of medication used to obtain the same level of pain reduction. Alternatively, or in combination with medication, electronic stimulation (“e-stim”) devices have been found to encourage improved physiological conditions that promote improved healing times and effectively reduce pain levels. Therapies, including heat, compression, and vibration, have also been found to reduce pain and promote wound healing.

One way in which a medical device reduces pain is by encouraging repair of muscular tissue. This treatment aims to improve the range of joint movement and to increase muscular strength and motor control. Similarly, it is desirable to reduce muscular atrophy and improve localized blood flow. Tissue repair is accomplished by enhancing microcirculation and protein synthesis to promote wound healing. Similarly, it is desirable to restore the integrity of connective tissue and dermal tissues. With regard to acute and chronic edema, desirable physiological responses include accelerating the absorption rate of lymphatic fluid and increasing blood vessel permeability. These goals are accomplished by increasing peripheral blood flow, including inducing arterial, venous, and lymphatic flow, thereby increasing the mobility of proteins, blood cells, and lymphatic fluid. A related desired outcome, known as iontophoresis, increases the efficiency of the delivery of pharmacological agents to a patient by increasing physiological responses, such as cell-uptake, diffusion rates, and mobility of fluids through tissue. In combination, these physiological responses effectively reduce healing time, pain and discomfort, and the need for rehabilitative services. In addition, patients are better able to function socially, physically, and emotionally, when pain is effectively managed and wound healing occurs quickly.

E-stim devices achieve the physiological conditions described above by exposing muscle and nerve cells to an electric current to polarize the cell membrane. Cell permeability is voltage-sensitive, producing an unequal distribution of charged ions on each side of the cell membrane creating a difference in electrical charge between the interior and exterior of the cell. Through a process known as “active transport,” positively charged sodium particles diffuse out of the polarized cell while negatively charged potassium ions flow inward. While a higher concentration of potassium collects inside the cell than outside, the overall charge difference produces a charge gradient in which the outside of the cell is positively charged and the cell interior has a negative charge.

Electrotherapeutic devices used in rehabilitation generate alternating current, direct current microcurrent, millicurrent, interferential current, pre-modulated current, and/or Russion-type current. These currents are introduced into biological tissues and are capable of producing specific and desirable physiological changes in the body. In alternating current, the electrons constantly change directions, reversing polarity. Electrons flowing in alternating current always move from the negative to positive pole, reversing direction when the polarities are reversed. Conversely, direct current refers to a unidirectional flow of electrons toward a positive pole. However, on most modern direct-current devices, the polarity and thus the direction of current flow can be reversed. Electrotherapeutic devices are usually further classified as being either high-voltage generators or low-voltage generators. The high-voltage devices produce waveforms (i.e., the visual representation of the current or voltage) with an amplitude in excess of 115 volts of relatively short duration (e.g., less than 10 milliseconds).

Commercially available medical devices rely on e-stim principles for therapeutic purposes. Transcutaneous electrical nerve stimulation (TENS) is a device that uses an electric current to stimulate nerve cells to reduce acute and/or chronic pain. Research studies show that high- and low-frequency TENS produce pain reducing effects by activating opioid receptors in the central nervous system. High-frequency TENS activates delta-opioid receptors both in the spinal cord and supra-spinally (in the medulla). Further, high-frequency TENS reduces the excitation of central neurons that transmit nociceptive information, reduces release of excitatory neurotransmitters (glutamate), increases the release of inhibitory neurotransmitters (GABA) in the spinal cord, and activates muscarinic receptors centrally to produce analgesia; in effect, temporarily blocking the pain gait. In contrast, low-frequency TENS activates beta-opioid receptors both in the spinal cord and supra-spinally. Low-frequency TENS also releases serotonin and activates serotonin receptors in the spinal cord, releases GABA, and activates muscarinic receptors to reduce excitability of nociceptive neurons in the spinal cord.

In contrast to TENS, which applies electric current to nerve cells, e-stim may also be applied directly to muscle cells. Electrical muscle stimulation (EMS), also known as neuromuscular electrical stimulation (NMES) or electromyostimulation, is the elicitation of muscle contraction using electric impulses. The impulses are generated by the e-stim device and delivered through electrodes on the skin in direct proximity to the muscles to be stimulated. The impulses mimic the action potential originating from the central nervous system. Stimulation causes the muscles to contract.

A second form of muscular stimulation using a lower stimulation voltage changes the physiology of the muscle cell, but does not cause muscle contraction. Micro current electrical neuromuscular stimulator (MENS) (also known as micro amperage electrical neuromuscular stimulator) is a device used to send weak electrical signals into the body. In contrast to TENS, which uses electric current (such as in the range of about 80 to about 100 mA), current produced by a MENS electrode is normally less than 1 milli-ampere. It is realized that microcurrent specific frequencies are capable of inhibiting inflammatory peptides called cytokines (e.g., IL-6, IL-8, TNF-alpha, CGRP, and the like). As with TENS, electrodes are placed on the skin. Micro-current is a physiological electric modality that increases the healing rate of body tissue by increasing cellular ATP (energy) production. The almost immediate response to the correct micro current suggests that other mechanisms are involved as well. Research has shown that micro-current increases the production of ATP (chemical energy produced by the body), by up to 500%. It also increases the role of protein synthesis and waste product removal.

A related e-stim treatment is iontophoresis or Electromotive Drug Administration (EMDA) which uses a small electric charge to essentially “deliver” a medicine or other chemical through the skin. Iontophoresis is a non-invasive method of propelling high concentrations of a charged substance, normally a medication or bioactive agent, transdermally by repulsive electromotive force. In practice, using a small electrical charge is applied to an iontophoretic chamber containing a similarly charged active agent and its solvent, appropriately referred to as a vehicle. The charge (either positive or negative depending on the polarity of the active agent and solvent) drives the contents from the chamber and to the skin of a patient. In such a manner, the active agent is effectively delivered to the patient.

Compression therapy has also been found to achieve desirable therapeutic results related to pain management and wound healing. Compression of specific extremities has been discovered to increase blood circulation. As described above, increased circulation has numerous therapeutic benefits related to tissue healing, pain reduction, and injury prevention. Similarly, thermal treatments such as providing heat or cooling an injured region of skin tissue has been found to increase blood flow and improve wound healing.

As has been described, each of these treatment systems provides desirable therapeutic benefits for patients enduring specific types of pain or chronic disease. However, for some users, each of these therapies has been found to cause pain during treatment. Therefore, there is a need for a medical device or system which counteracts, inhibits, or prevents pain from the injured tissue itself as well as from therapeutic treatments such as electrical stimulation, drug delivery, and tissue compression. Furthermore, in some circumstances, patients would benefit from a treatment regiment which uses several treatment options in combination to achieve superior therapeutic results. Similarly, patients would benefit from being able to alternate between treatments or to modify the type of treatment received based on how they are feeling at a particular time. Desirably, this device would effectively reduce pain and encourage wound healing to such an extent that the patient could significantly reduce or entirely cease the use of medication.

In view of these desired goals, there is a need for a medical device that effectively reduces pain and improves wound healing.

### SUMMARY OF THE INVENTION

Generally, provided are pain management devices and systems that address or overcome some or all of the deficiencies and/or drawbacks discussed above. Preferably, provided are pain management devices and systems that offer vibration therapy in combination with other therapeutic treatments for improved pain management and wound healing. Preferably, provided are pain management devices and systems that are useful for providing palliative care, reduced inflammation and lymph edema, tissue repair, increased joint mobility, increased motility of proteins, blood cells, lymphatic and blood flow, and iontophoresis.

Accordingly, provided is a vibration device for providing a vibration sensation to a user includes a base, a vibrating element, a power source, and an actuation mechanism. The actuation mechanism is configured to facilitate an electrical connection between the power source and the vibrating element, thereby causing the vibrating element to vibrate. In one preferred and non-limiting embodiment, the actuation mechanism includes a member slidably disposed between the vibrating element and the power source, such that removing the member establishes this electrical connection.

In certain preferred and non-limiting embodiments, the vibration device further includes a printed circuit board connected to the vibrating element and power source, the printed circuit board including a circuit for selectively establishing the electrical connection between the vibrating element (such as a motor or the like), and the power source. The vibrating element and power source may be disposed on a top surface of the printed circuit board and the base may be disposed below the printed circuit board. Alternatively, the power source may be positioned above the printed circuit board, and the vibrating element may be positioned below the printed circuit board.

In certain preferred and non-limiting embodiments, the base includes a cushioned pad. The base may further include an adhesive arrangement (such as an applied adhesive material, a removable adhesive arrangement, an adhesive surface, or the like) configured to affix the vibration device to the skin of the user. Optionally, the base also includes a therapeutic agent, such as a chemical agent, capable of diffusing through the skin of a user. The actuation mechanism may include an on/off button, an on/off timer, a pulsing mechanism, and/or a vibration intensity modifier. In other preferred and non-limiting embodiments, the power source includes or is in the form of a battery, a disposable battery, and/or a rechargeable battery. Optionally, the device may further include a clip at least partially surrounding the battery. The clip includes at least one prong for contacting a terminal of the battery, and at least one leg in electrical connection with the vibrating element for establishing the electrical connection between the battery and the vibration element through the clip.

In accordance with a further aspect of the invention, a system for providing a vibrating sensation to a user for pain management and improved wound healing is provided. The system includes a base, a vibrating element, and a controller in electrical communication with at least one of the base and the vibrating element. Optionally, the system includes a plurality of electrodes configured to contact the skin of a user for providing electrical stimulation to the user, and the controller provides power to the vibrating element and electrodes, and controls the electrical output of the electrodes. Optionally, the electrodes are configured to provide one or more of the following therapies: neuromuscular electrical stimulation (NMES), micro current electrical neuromuscular stimulator (MENS), electrical muscle stimulation (EMS), transcutaneous electrical nerve stimulation (TENS), and iontophoresis. The system may further include one or more physiological sensors for monitoring the physical condition of the user, as well as a thermal element configured to provide a hot or cold sensation to the user.

In certain configurations, the base includes a compression sleeve configured to provide a compression gradient along the sleeve, such as a compression gradient in which compression force increases or decreases longitudinally along the sleeve. Optionally, the compression sleeve includes at least one constricting element for increasing the constricting force of the sleeve.

In certain further configurations, the system includes an external data transfer system. The data transfer system includes a data transmitter for establishing a wired or wireless connection and transmitting data between the controller and at least one data analysis device. The data may include operating data about operation of the various components of the device and/or physiological data collected by the sensors. The data analysis device includes a microprocessor for processing the data received from the data transmitter. Optionally, the microprocessor of the at least one data analysis device records what treatments are provided to the user and determines the physiological effects of the treatments on the user at least partially based upon the data from the physiological sensors.

In accordance with a further preferred and non-limiting embodiment of the invention, provided is a method of manufacturing a vibration device for providing a vibrating sensation to a user, including: providing a substrate layer; forming at least one circuit board on the substrate layer; the at least one printed circuit board including embedded circuitry for establishing an electrical connection between electrical components; affixing a vibrating element to the at least one printed circuit board (and, optionally, affixing a power source); and, connecting an actuation mechanism between a power source and the vibrating element element, the actuation mechanism configured to selectively establish an electrical connection between the battery and the vibrating element (e.g., a motor), thereby causing the vibrating element to vibrate.

The device may work in connection with other known therapies including various e-stim processes, compression, and/or hot and cold therapies. In one preferred and non-limiting embodiment, the device provides various therapeutic benefits, including, but not limited to: decreasing healing time for wounds and injuries; reducing swelling, pain, discomfort, and lymphedema; supporting blood and lymph flow; increasing blood, oxygen, and nutrients to affected areas; and, increasing the range of motion for muscles and joints thereby allowing the patient to return to prior function levels more quickly. Additionally, the device may be designed so that various components overlap or perform more than one function, thereby reducing the size and cost of the device. Further, the system may be configured to record data during treatment so that the effectiveness of the various treatment methods can be better understood and future treatment regiments, for individual patients, more accurately determined.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1A is a perspective view of a vibration device for providing vibration therapy to a user, in accordance with an embodiment of the present invention;

FIG. 1B is a top view of the vibration device of FIG. 1A;

FIG. 1C is a side view of the vibration device of FIG. 1A;

FIG. 1D is an exploded perspective view of the vibration device of FIG. 1A;

FIG. 2 is a schematic drawing of a printed circuit board for use in the vibration device of FIG. 1A;

FIG. 3A is a perspective view of a vibration device for providing vibration therapy to a user, in accordance with an embodiment of the present invention;

FIG. 3B is a top view of the vibration device of FIG. 3A;

FIG. 3C is a side view of the vibration device of FIG. 3A;

FIG. 3D is an exploded perspective view of the vibration device of FIG. 3A;

FIG. 4 is a schematic drawing of a printed circuit board for use in the vibration device of FIG. 3A;

FIG. 5 is a perspective view of a vibrating motor attached to a printed circuit board, in accordance with an embodiment of the present invention;

FIG. 6 is a schematic drawing of a substrate for use in manufacturing a printed circuit board for use with a vibration device, in accordance with an embodiment of the present invention;

FIG. 7A is a perspective view directed to a top portion of a pain management device, in accordance with an embodiment of the present invention;

FIG. 7B is a perspective view directed to a bottom portion of the pain management device of FIG. 7A;

FIG. 7C is a magnified perspective view of the device of FIG. 7A;

FIG. 7D is a perspective view of the device of FIG. 7A, with a heating element depicted in phantom;

FIG. 8 is an exploded perspective view of the device of FIG. 7A;

FIG. 9 is a schematic drawing of a circuit including electrical elements of the pain management device and a controller, in accordance with an embodiment of the present invention;

FIG. 10 is a perspective view of an embodiment of the pain management device including a compression sleeve, in accordance with an embodiment of the present invention;

FIG. 11 is a side view of the pain management device of FIG. 10 including a vibrating motor and pressure sensor for modifying the compressive force of the compression sleeve;

FIG. 12 is an illustration of a pain management device including additional pad elements according to an embodiment of the present invention;

FIG. 13 is a schematic drawing of a system for transferring, storing, and/or analyzing data, including a pain management device and an external analysis device, all in accordance with an embodiment of the invention;

FIG. 14 is an illustration of a smart phone showing an icon for accessing an application for controlling the pain management device in accordance with an embodiment of the invention;

FIG. 15 is an illustration of a smart phone running the application for controlling the pain management device, in accordance with an embodiment of the present invention; and,

FIG. 16 is a schematic drawing depicting a vibrating device according to the present invention configured to provide a therapeutic agent to a user by iontophoresis.

### DESCRIPTION OF THE PREFERRED EMBODIMENTS

The following description is provided to enable those skilled in the art to make and use the described embodiment set forth herein for carrying out the invention. Various modifications, equivalents, variations, and alternatives, however, will remain readily apparent to those skilled in the art. Any and all such modifications, variations, equivalents, and alternatives are intended to fall within the spirit and scope of the present invention.

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

With reference to the Figures, the present invention is drawn to devices and systems for providing a vibrating sensation to a user. Vibration provides numerous therapeutic benefits, including pain management for targeted muscle groups. In addition, vibration force has the additional therapeutic effect of increasing skin surface stimulation. The increased stimulation warms skin cells and promotes oxygen flow. As a result, iontophoresis occurs more quickly allowing drug delivery into the skin more efficiently and with deeper penetration than occurs with electronic stimulation alone. A further desirable therapeutic response can be achieved by exerting vibration forces to muscle tissue. Research has shown that muscle units and muscle fibers are activated more efficiently under vibration than through normal conscious muscle contractions. See generally, Delecluse et al. International Journal of Sports Medicine 26(8):662-8 (2005); Lamont et al. Poster presentation ACSM (2006); Cormie et al. Journal of strength and conditioning research/National Strength & Conditioning Association 20(2):257-61 (2006). The immediate effect of whole body vibration (WBV) is that muscles can be contracted more quickly and efficiently, rendering the muscle capable of producing increased force. Another immediate effect of WBV is improved circulation. The rapid contraction and relaxation of the muscles at approximately 20 to 50 times per second essentially works as a pump on the blood vessels and lymphatic vessels increasing the speed of blood flow through the body. See Kerschan-Schindl et al., Clinical physiology (Oxford, England), 21(3) (2001). Additional research describes the appearance of vasodilatation (widening of the blood vessels) as a result of vibration. See Stewart, et al., American journal of physiology. Regulatory, integrative and comparative physiology 288(3):R623-9 (2005); Oliveri American journal of physical medicine & rehabilitation/Association of Academic Physiatrists 68(2):81-5 (1989).

In addition to the influence on muscular tissue, WBV also provides a positive effect on bone mineral density. Vibrations cause compression and remodeling of the bone tissue activating the osteoblasts (bone building cells), while reducing the activity of the osteoclasts (cells which break down bone tissue). Repeated stimulation of this bone building/break-down system, combined with the increased pull on the bones by the muscles, increases bone mineral density over time. Further research suggests that improved circulation and bone perfusion, also promoted by vibration therapy, leads to better intra cellular nutrient supply. See Roelants et al., Journal of the American Geriatrics Society 52(6): 901-8 (2004).

In addition to the pain reduction and wound healing benefits described above, vibration therapy (as provided by the presently-invented vibration device and system) is also useful for preventing or treating the following conditions: arthritis, myalgia, inflammation, rheumatoid arthritis, polyarthritis, arthritic conditions, prevention of deep venous thrombi, lymphedema, edema, psoriatic arthritic pain, headaches, and migraines. Vibration therapy also provides an effective distraction or counter to reduce pain from injections, such as injections for drug delivery, and from stimulation electrodes in an e-stim system.

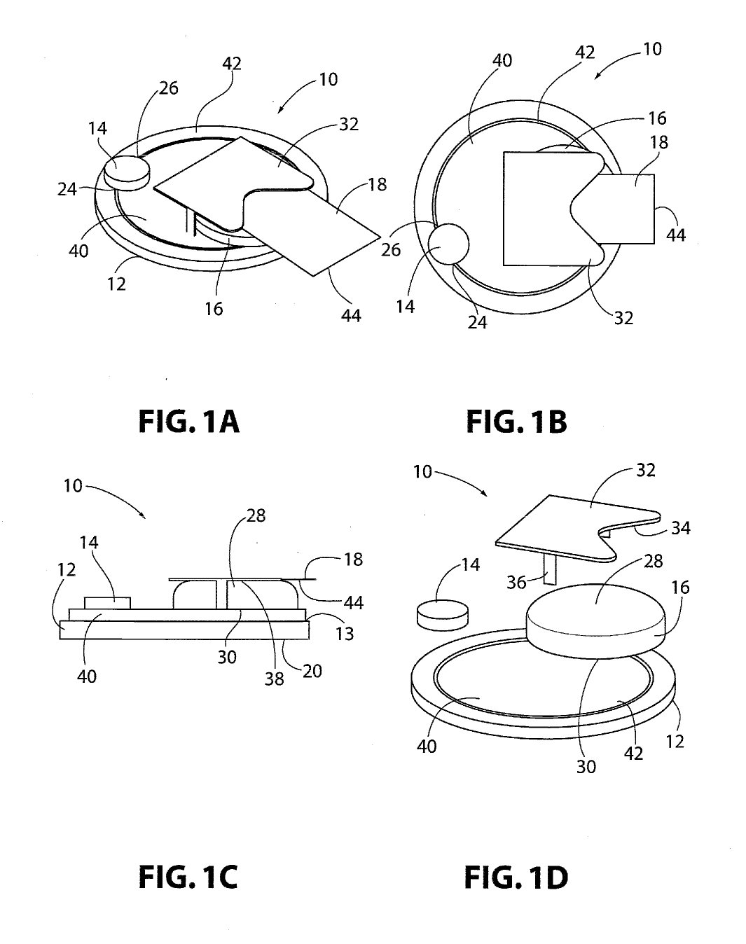

With particular reference to FIGS. 1A-1D, and in one preferred and non-limiting embodiment, a vibrating device 10 is designed to provide therapeutic benefits to users through a small, low-cost, and easy-to-use apparatus, which can be applied to the skin surface without medical supervision. The vibrating device 10 includes a base 12, a vibrating element, such as a motor 14, a power source, such as a battery 16, and an actuation mechanism 18 (i.e., some mechanism for facilitating operation of the device 10). The base 12 may be any structure configured for maintaining a connection between electrical components of the device 10 and the skin surface of a user. For example, the base 12 may be a pad or patch formed from a cushioned fabric for insulating the user from the other elements of the device 10. The base 12 may be manufactured from a variety of materials, dependent upon the desired application and result. For example, in certain embodiments, the base 12 is wholly or partially made from synthetic fiber cloth, foam, pre-formed conductive carbon-rubber, conductive carbon fiber, pure copper lead wires, carbon mesh, woven conductive fibers, fibrous material, woven material, conductive material, synthetic material, and the like. A surface of the pad may be covered by an adhesive arrangement, such as an adhesive material 20, for removably affixing the device 10 to the skin surface. Alternatively, the base 12 may simply include a piece of two-sided tape or other adhesive material as is known in the art.

In certain embodiments, the base 12 is associated with a medicated substance. For example, the surface of the base 12 may be impregnated with a medicated composition which, when in contact with a user's skin, diffuses into the body. Additionally, the surface of the base 12 may have a raised or rough surface to score the skin to increase the diffusion rate of the medicated substance. Alternatively, the user may rub a medicated cream, gel, or solution onto the skin prior to affixing the vibrating device 10 thereto. In another preferred and non-limiting embodiment, the base 12 is a standard pain relief patch for providing a therapeutic pain relief agent to a user such as Icy-Hot® pain relief patches sold by Chattem, Inc. of Chattangooga, Tenn., Bengay® adhesive patches sold by Pfizer Corp., or other known numbing or pain relief substances as is known in the art. In operation, the device 10 increases the diffusion rate of the medicated substance by increasing blood flow and arterial dilation in the skin region that receives the vibrating treatment.

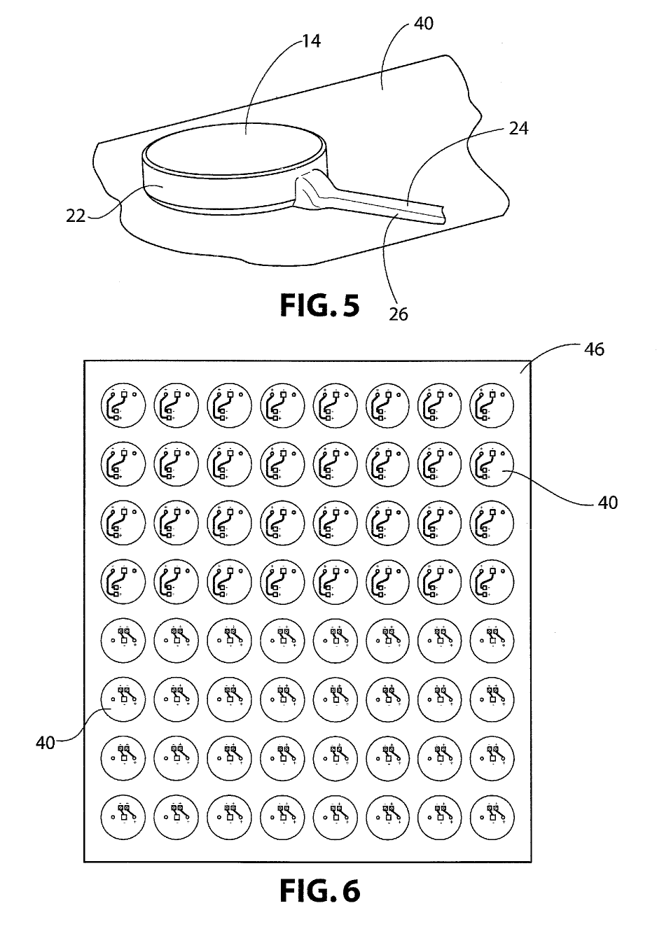

In one preferred and non-limiting embodiment, the vibrating element, e.g., the motor 14) is connected to an upper surface 13 of the base 12. With specific reference to FIG. 5, the motor 14 may be an electric disk motor (also known as a coin vibrating motor), as is known in the art. The motor 14 includes a cylindrical housing 22, which may be formed from metal or hard plastic. The housing 22 encloses a vibration mechanism, such as a movable bearing acted on by an annular magnet. Other configurations for small vibrating motors, as are known in the art, may also be used within the scope and context of the present invention.

With continued reference to FIGS. 1A-1D, a positive lead 24 and a negative lead 26 extend from the motor housing 22 for connection with a corresponding positive terminal 28 and negative terminal 30 of the battery 16. As is known in the art, the battery 16 includes one or more electrochemical cells that convert stored chemical energy into electrical energy. Within the scope and context of the present invention, the battery 16 may be a single-use disposable battery or a rechargeable battery. One non-limiting example of a useful battery is a lithium-ion battery. A lithium-ion battery is a rechargeable battery often used in electronic devices. Other types of batteries, adaptable for use in the device 10 include nickel cadmium (NiCd) and nickel medal hydride (NiMH) batteries.

In one preferred and non-limiting embodiment of the device 10, the battery 16 is configured to contain a sufficient charge to operate the motor 14 for a predetermined treatment time. In this way, the vibrating device 10 operates until the battery charge expires. Once the battery 16 expires, the user can dispose of the battery 16 and/or the entire device 10. Accordingly, the user does not need to monitor the duration of the vibrating treatment. The motor 14 automatically turns off when the battery 16 expires.

In certain preferred and non-limiting embodiments, the battery 16 is a metallic disk having a flat top and bottom surface and a cylindrical sidewall. The positive terminal 28 of the battery 16 is disposed on the top surface of the battery 16 and the negative terminal 30 is disposed on the bottom surface. The battery 16 may be held in place by a clip 32, formed from a suitable conductive material, such as metal. The clip 32 includes a pressing surface 34 and two legs 36 extending therefrom. A prong 38 extends from underneath the pressing surface 34 and is configured to contact the positive terminal 28 of the battery 16. Electrical charge is carried through the clip 32 to the legs 36. A conductive element, such as a wire, may be connected to the legs 36 to establish an electrical connection with the battery 16 through the clip 32. For example, the positive lead 24 of the motor 14 may be connected to one of the legs 36 of the clip 32. The negative lead 26 may be connected directly to the negative terminal 30 of the battery 16. In this way, a circuit including the battery 16 and motor 14 is formed.

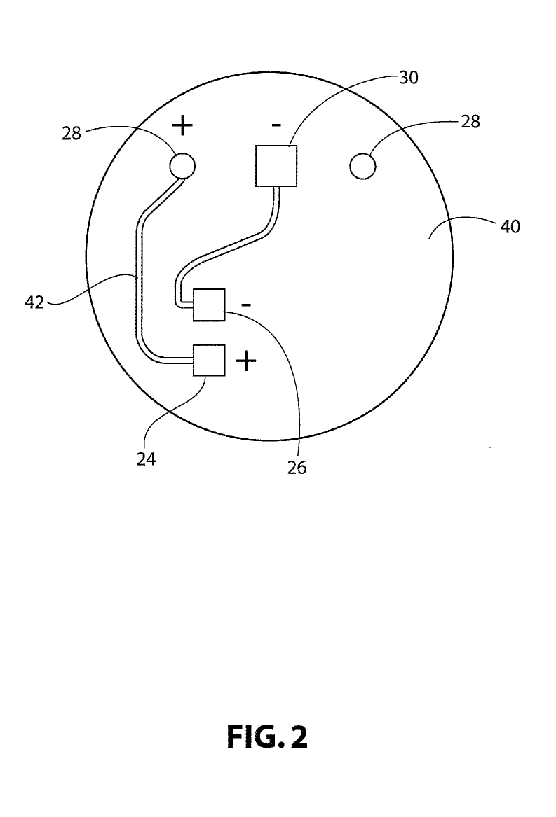

With continued reference to FIGS. 1A-1D, in certain preferred and non-limiting embodiments, the device 10 further includes a printed circuit board 40. The printed circuit board 40 is formed from any suitable and easily manufactured substrate as is known in the art. The printed circuit board 40 includes embedded circuitry 42, known as traces, for establishing an electrical connection between the battery 16 and an electric device, such as the motor 14. In the embodiment of the device depicted in FIGS. 1A-1D, the battery 16 and motor 14 are both disposed on top of the printed circuit board 40. More particularly, the negative terminal 30 of the battery 16 is directly connected to the printed circuit board 40. The clip 32 covers the battery 16 and is configured such that the legs 36 contact the printed circuit board 40 to establish electrical connection therewith. The motor 14 is also connected to the printed circuit board 40. The leads 26, 28 of the motor 14 are connected to corresponding connectors of the circuit board 40 to establish a circuit including the motor 14 and battery 16. The leads 26, 28 may be connected to the printed circuit board 40 by any known means such as by soldering, an adhesive, or with a connection structure, such as a clip. A schematic diagram of an exemplary printed circuit board of the device 10 is depicted in FIG. 2.

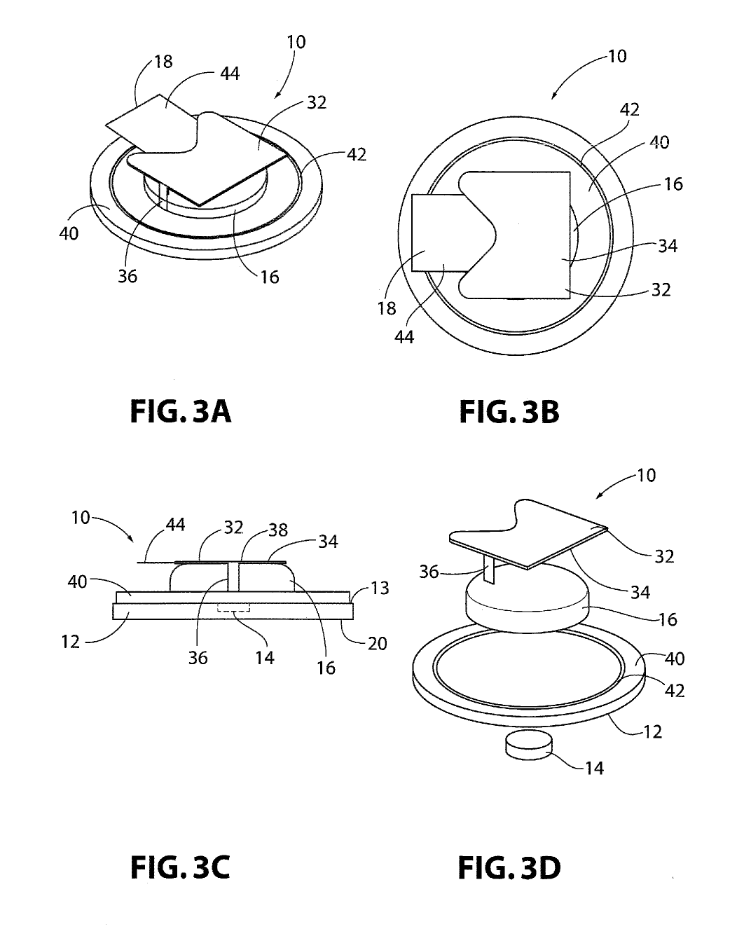

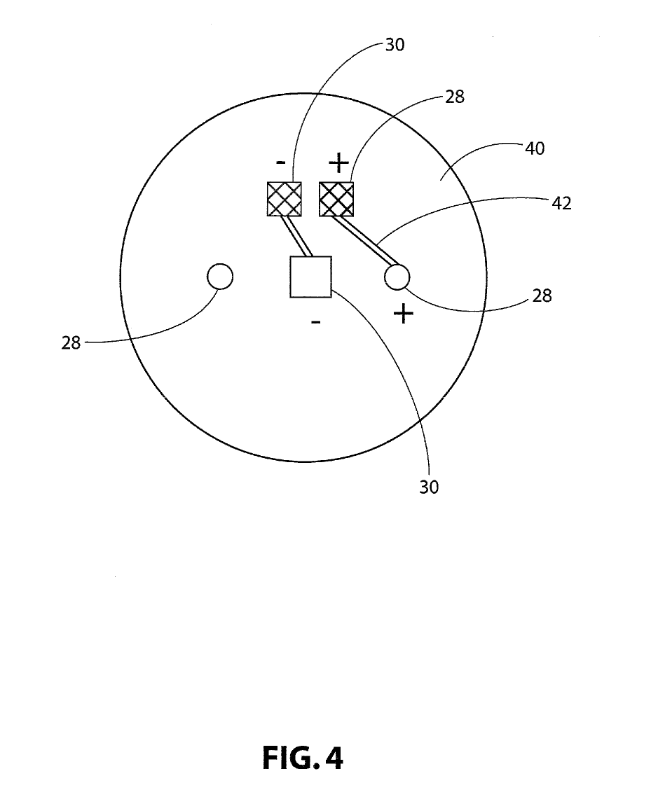

With reference to FIGS. 3A-3D, in a further preferred and non-limiting embodiment of the device 10, the motor 14 and battery 16 are disposed on opposite sides of the printed circuit board 40. As shown in FIG. 3A, the motor 14 is placed between the printed circuit board 40 and the base 12. Placing the motor 14 in closer proximity to the user provides a different therapeutic vibrating sensation to the user. For example, placing the motor 14 closer to the skin may result in a more concentrated and targeted vibration sensation. A schematic drawing of the printed circuit board 40 for use with the embodiment of the device 10 depicted in FIGS. 3A-3D, is depicted in FIG. 4.

With reference now to FIGS. 1A-3D, and in another preferred and non-limiting embodiment, the device 10 further includes the actuation mechanism 18 or arrangement for controlling (e.g., turning “on” and “off”, controlling vibration frequency, intensity, duration, etc.) the vibrating motor 14. In one preferred and non-limiting embodiment, the actuation mechanism 18 includes a thin slidable member 44, such as a polymer film, inserted between the prong 38 of the clip 32 and the positive terminal 28 of the battery 16. When the member 44 is in place, contact between the battery 16 and clip 32 is prevented. Accordingly, the motor 14 does not receive power from the battery 16. To actuate the device 10, a user grasps the member 44 and pulls it away from the clip 32. Once the member 44 is removed, an electrical circuit is established between the motor 14 and battery 16 causing the motor 14 to vibrate. As described above, in certain embodiments, the battery 16 is configured to expire after a suitable treatment time, such that the member 44 may be a removable tab or the like. In that case, there is no need to include a mechanism for turning off the motor 14. However, the user could interrupt the circuit and stop vibration simply by re-inserting the thin member 44 between the prong 38 and battery 16.

In an alternative preferred and non-limiting embodiment, the actuation mechanism 18 includes an on/off switch or button, as is known in the art. In certain embodiments, the actuation mechanism 18 may also include electrical components for modifying vibration frequency, intensity, or duration. For example, the electrical components may be configured to provide an intermittent or pulsing vibration sensation. Such control could be provided through known arrangements, such as a sliding tab, a rotatable knob, a digital input device, and the like.

Having described the vibrating device 10 according to the present invention, a method of manufacturing said device 10 is now provided. In one non-limiting embodiment, a method of manufacturing the vibrating device 10 includes providing a substrate 46 to be used to form the printed circuit board 40. As is known in the art, the substrate 46 may be a multi-layer laminate including layers of cloth or paper enclosed by a thermoset resin. Substrates formed from copper and copper foil are also known in the art. The printed circuit board 40 includes the embedded circuitry 42, namely metallic traces etched to the board surface. The traces, which are formed from a conductive material, such as copper, are used to create circuits between various electrical elements coupled to the board. The traces may be formed by patterning, etching, or certain additive methods as is known in the art. For example, a thin conductive layer, such as a copper layer, may be placed on the substrate 46. Portions of the copper layer may be etched away, leaving the traces on the substrate 46 surface.

As depicted in FIG. 6, and in one preferred and non-limiting embodiment (where multiple devices 10 are formed in the process), the substrate 46 is a large flat sheet. Numerous individual printed circuit boards 40 are formed on the sheet. In certain preferred and non-limiting embodiments, different configurations of printed circuit boards 40 may be printed on the same sheet, so that various configurations of the device can be manufactured simultaneously. For example, as shown in FIG. 6, the top half of the substrate 46 includes printed circuit boards 40 configured to include the motor 14 and battery 16 on the same side of the device 10 (as shown in FIG. 2) while the lower half of the substrate 46 includes boards 40 configured to include the motor 14 and battery 16 on opposite sides of the device 10 (as shown in FIG. 4). After the individual boards 40 are printed, the substrate 46 is divided by a cutting process as is known in the art, forming numerous individual printed circuit boards 40.

Once an individual printed circuit board 40 is obtained, the electrical components, including the motor 14 and battery 16, are connected to the printed circuit board 40. The electrical connection between the motor 14 and battery 16 are connected through the embedded circuitry 42 formed on the printed circuit board 40. The actuation mechanism 18 may also be installed which, as is described above, permits for selectively establishing flow of electric current from the battery 16 to the motor 14. In certain embodiments, the clip 32 which covers the battery 16 and which forms an electrical connection between the positive terminal 28 of the battery 16 and the printed circuit board 40, may also be installed. The printed circuit board 40 and electrical components are then connected to the base 12 by any known means. For example, the base 12 may be glued to the device using a known adhesive. The base 12 may also be connected using tape, fasteners, screws, clips, or any other suitable connection means as is known in the art.

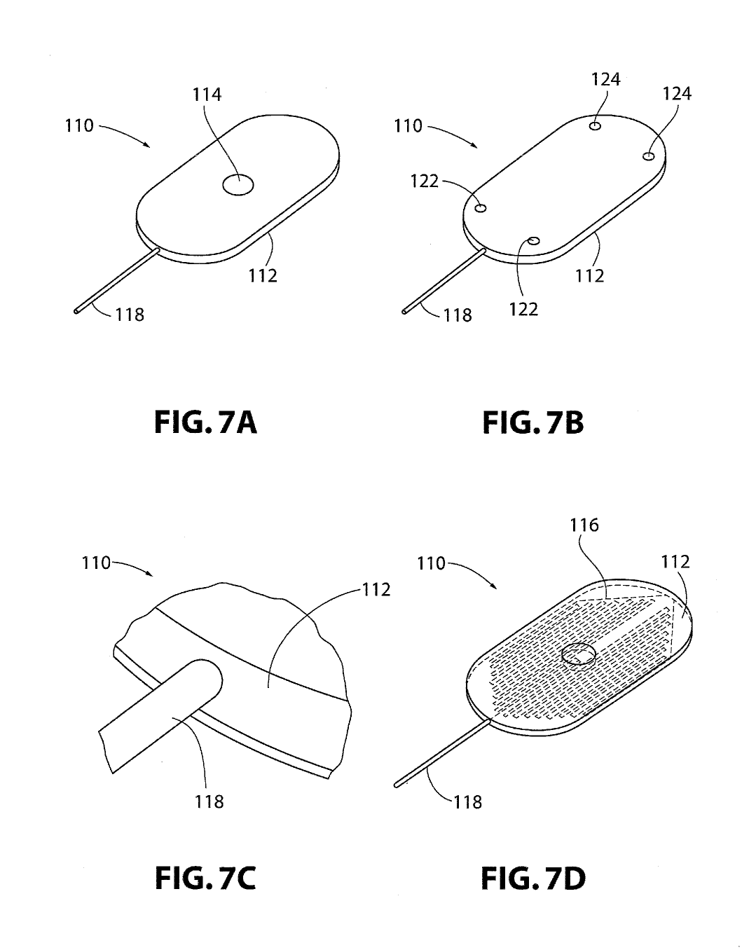

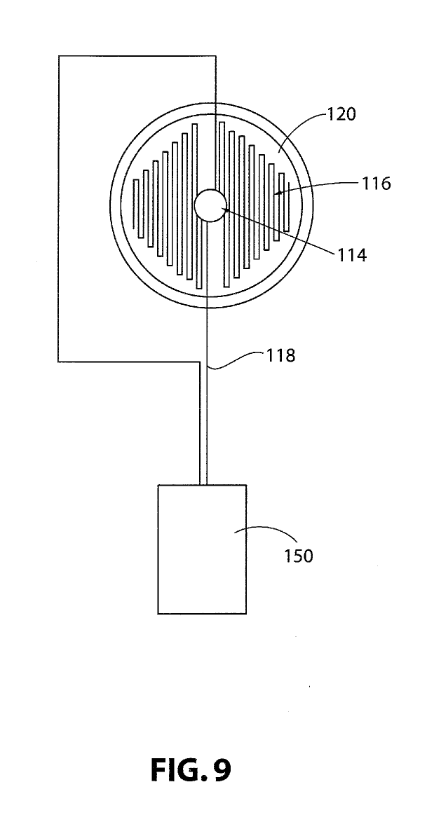

Having described a device for providing vibration therapy and a method of manufacture thereof, a pain management device 110 for providing vibration therapy in combination with other therapeutic treatments is now described. One preferred and non-limiting embodiment of the pain management device 110 according to the present invention is shown in FIGS. 7A-9.

With reference to FIGS. 7A-9, the pain management device 110 includes a pad cover 112 enclosing a pad 120. It will be readily apparent to those skilled in the art, however, that the pad 120 depicted in FIGS. 7A-9 represents but one of a wide variety of structures and configurations which fall within the scope and context of the present invention. The pad 120 and/or pad cover 112 may be manufactured from a variety of materials, dependent upon the desired application and result. In one preferred and non-limiting embodiment, the pad 120 is a existing standard pad for use with stimulation electrodes modified to include additional elements of the present invention. These additional elements may be inserted in or affixed to the standard stimulation electrode pad 120 by any suitable connection means, as is known in the art, including, but not limited to, adhesive gels, adhesive tapes, or metallic fasteners. In this way, existing technology drawn to stimulation electrodes and electrode pads can be modified to include additional therapeutic options including, but not limited to, vibration, heat/cool therapy, and compression, in accordance with various embodiments of the present invention. These additional therapeutic options are described below in greater detail.

Optionally, the pad 120 includes a medicated element (not shown) for administering medicine to the patient through the skin surface. For example, medication may be contained within a cavity covered by a dissolvable membrane. The medication membrane dissolves upon warming to a predetermined temperature. Upon dissolution of the membrane surface, the medication is administered through contact with the skin. The temperature threshold for membrane dissolution may be reached by body temperature or through actuation of the thermal element 116. The medication pre-loaded in to the pad 120 may be a medicated cream, gel, or solution as is known in the art. The medication may be ionized, thereby increasing the rate and depth of iontophoresis.

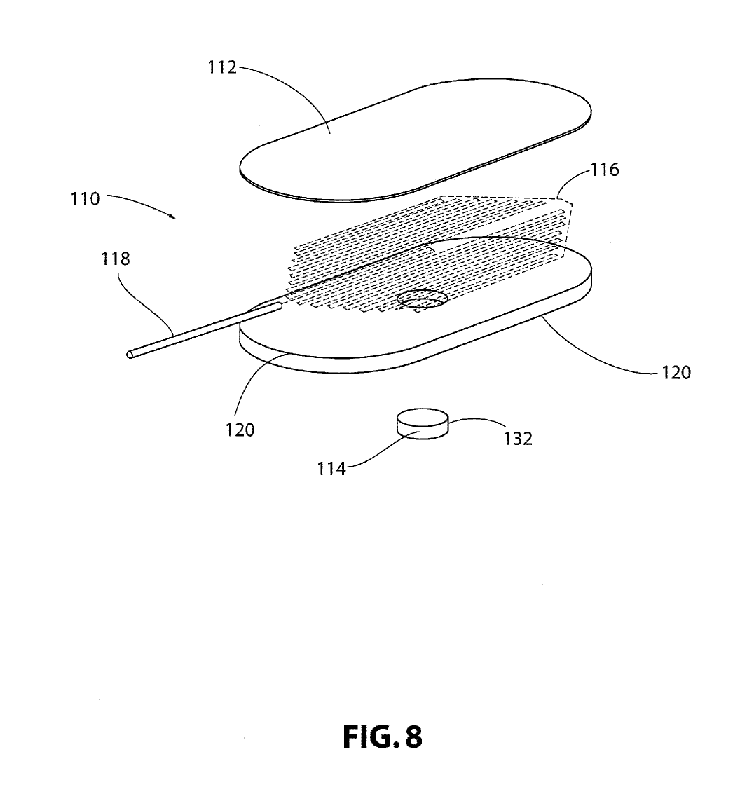

With continued reference to FIGS. 7A-9, and in one preferred and non-limiting embodiment, enclosed within the pad cover 112 is a plurality of electrical components including the vibrating actuation device (e.g., a motor 114) and a plurality of electrodes 122 for providing electrical stimulation of body tissue (e.g., NMES, MENS, EMS, TENS). Optionally, as will be described in greater detail below, the pad 120 may further include a heating element 116 and feedback functionality and/or components, such as physiological sensors 124 for determining the physical condition of the user. The pad 112 is connected to an external electrical stimulation unit (e.g. a controller unit) by wire leads 118. An expanded view of the device 110 is depicted in FIG. 8.

The motor 114 is disposed within the pad 120 or pad cover 112. As was the case with the motor in previously-described embodiments of the invention, the motor 114 may be a disk motor having a cylindrical housing 132 with lead wires extending therefrom. In one non-limiting embodiment, the device 110 includes a plurality of motors 114 within the pad 120 or pad cover 112. For example, each electrode 122 may be positioned in close proximity to a vibrating motor 114. Additionally, different motors 114 may be configured with different vibration characteristics to provide a variety of vibration sensations to a user. Alternatively, the user may wear a number of pads 120 containing motors 114 on different parts of the body, at the same time, to simultaneously provide targeted vibration therapies to different body regions.

Unlike other embodiments of the invention, in which the power source, actuation mechanisms, etc. were included on the device itself, such as the device depicted in FIGS. 7A-9, in this preferred and non-limiting embodiment, the electrical components are connected to an external controller 150 through wire leads 18 (making the battery and associated electrical connection unnecessary). In certain preferred and non-limiting embodiments, the connection between the wearable portion of the device 110 and the controller 150 may also be a wireless connection including a wireless transmitter disposed on the wearable portion of the device 110 and a wireless receiver coupled to the controller 150.

In one preferred and non-limiting embodiment, the controller 150 performs various functions related to directing and monitoring use of the vibrating motor 114, including turning the motor “on” and “off”, increasing vibration intensity, modifying vibration frequency, and the like (as discussed above). Optionally, the controller 150 may also be configured to provide more specific and sophisticated treatment regimens for a user. For example, the controller 150 may provide vibration in accordance with a programmable and pre-determined on/off alternating sequence. The sequence may be configured specifically to correspond with and enhance the other therapeutic functions of the wearable device including, but not limited to, electronic stimulation, heat/cold therapies, etc. For example, the controller 150 may be programmed to increase vibration intensity as heat or electronic stimulation increases to counteract the increased pain caused by these treatments. Alternatively, the vibrating motor 114 may be configured to gradually increase vibration intensity during a treatment session, thereby giving the user ample opportunity to adjust to the feel of the vibration treatment at low intensity before being exposed to higher intensity treatments. The controller 150 may also be configured to provide vibration therapy concurrently or independently from other therapies provided by the device including thermal hot/cold therapy, electrical simulation therapy, or compression therapy.

Stimulation electrodes 122 are also enclosed within the pad 120, generally in close proximity to the motor 114. The stimulation electrodes 122 are capable of performing one or more electronic stimulation therapies, including, but not limited to, NMES, MENS, EMS, TENS. Electrical stimulation is painful for some users. It has been determined that providing a vibration element, such as motor 114, in close proximity to the electrodes 122, can reduce pain experienced by a user during electrical stimulation procedures. As described above, the use of such stimulation electrodes 122 promote wound healing and reduce pain by providing targeted therapeutic amounts of electronic current to body tissue. Generally, a TENS electrode delivers currents up to 80 mA. In contrast, microcurrent treatments (e.g., NMENS, MENS) provides electrical current “doses” of about 8 mA, but may operate at levels as low as 900 μA. Preferred and non-limiting specifications for TENS electrical stimulation electrodes are included in Table 1.

TABLE 1

| | |
|---|---|
| Frequency | 0.3, 8, and 80 Hz |
| Volts & current | 0 to 4 volts, 0 to 8 mA (milliamps) |
| Max. charge per | 25 μC (micro coulombs) |
| Pulse shape | equi-biphasic square wave |
| Pulse cycle time | 3 seconds |
| Pulse width | 1666, 62, and 6.25 μS (corresponds to |
| | frequencies 0.3, 8, and 80 Hz) |
| Timer | variable |
| Amplitude Range | 0-900 mA, 0-8 mA |
| Pulse Repetition | .6, 10, 30, 300 Hz |

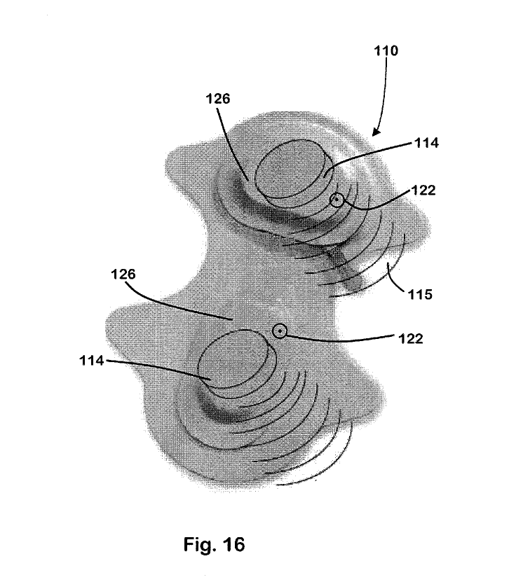

With particular reference to FIG. 16, in certain non-limiting embodiments, the electrical stimulation electrodes 122 are configured to improve the diffusion rate for a charged therapeutic agent 126 through a user's skin. As described above, the therapeutic agent 126 may be a drug containing solution, a gel or cream rubbed onto the skin prior to placing the device 110 on the user's skin, or a solid coating disposed on a bottom side of the device 110. The process of using electrical stimulation to encourage diffusion of charged particles to skin tissue is referred to as iontophoresis. Iontophoresis is painful for some users as a result of both the electrical charge itself and chemical reaction between body tissue and the diffused therapeutic agent 126. Vibration therapy is found to reduce pain, thereby increasing patient compliance with iontophoresis treatment regimes. It is further noted that vibration therapy can also be used as a counter irritant for other types of injections not limited to drug delivery. Therefore, in certain embodiments, the device 110 includes a vibrating element such as a motor 114 to provide vibration waves 115 to a user to counteract pain from the therapeutic agent 126 and stimulation electrodes 122. More particularly, vibration therapy has been found to effectively interrupt or cancel out pain receptors which typically activate during the iontophoresis process.

Additionally, it has also been determined that inclusion of a vibration component increases the effectiveness of the iontophoresis process by increasing the diffusion rate of the medical compound. More specifically, targeted vibration waves have been found to increase blood flow to skin tissue. Increased blood flow increases drug uptake through capillaries located near the skin surface, thereby increasing the overall drug delivery rate. For the iontophoresis process, it is recommended that the electrical components be capable of delivering a specified electrical dosage, e.g., at least about 80 mA at about 1.5 to about 10 volts. The electrodes may be interferential electrodes or pre-modulated electrodes. Suggested current industry specifications for iontophoresis electrodes are depicted in Table 2.

TABLE 2

| Parameter | Interferential | | Premodulated | |
|---|---|---|---|---|
| Function | Electrodes | | Electrodes | |
| Carrier Frequency | 5000 | Hz | 5000 | Hz |
| Beat Frequency | 0-200 | Hz | 0-200 | Hz |
| Scan Mode | On/Off | | N/A | |
| Scan Time | 15 | sec | N/A | |
| Sweep Time | 15 | sec | 15 | sec |
| Duty Cycle | N/A | | N/A | |
| Ramp Up/Ramp Down | N/A | | N/A | |
| Cycle Time | 15 | sec | N/A | |
| Alternating Time in Seconds | N/A | | N/A | |
| Polarity | N/A | | N/A | |
| Amplitude | 0-50 | mA RMS | 0-50 | mA RMS |
| Voltage | 200 | Volts | 200 | Volts |

With continued reference to FIGS. 7A-9, and in another preferred and non-limiting embodiment, the pain management device 110 also includes one or more thermal elements, such as a heating element 116. Increasing the temperature of the skin surface warms skin cells, opens pores, and promotes increased oxygen flow to peripheral skin cells. As with vibration treatment, these physiological effects increase the iontophoresis rate, delivering drugs into the skin more efficiently and with a deeper penetration than e-stim alone. In addition, cooling or chilling elements may also be utilized for those treatments that require cooling as opposed to heating. It is further noted that thermal hot/cold therapy provides many of the same benefits as vibration therapy, namely reducing pain by interrupting, blocking, or canceling pain recepters and increasing blood flow to target body tissues. Therefore, in certain embodiments of the invention, thermal therapy may be used in place of vibration therapy to counteract pain from the simulation electrodes, within the scope of the present invention. Therefore, in certain embodiments, the device includes the base 112, heating element 116, and control unit 150.

In further preferred and non-limiting embodiments, the device 110 includes additional electrical components, such as one or more physiological sensors 124 for monitoring the physiological condition of the user while using the device 110. One such physiological sensor 124, a pulse oximeter (saturometer), is an apparatus that indirectly monitors the oxygen saturation of a patient's blood (without requiring a blood sample) and changes in blood volume in the skin, producing a photoplethysmograph. A pulse oximeter measures the transmittance of a small pair of light-emitting diodes (LEDs) through a translucent part of the skin, typically but not limited to a finger tip and/or ear lobe, with a photodiode. The measured transmittance relates to the amount of red arterial blood in the section of skin and corresponds to the oxygen saturation of the blood. The oximeter is often attached to a monitor in order to provide a constant record of the patient's oxygenation levels. The monitor also displays a patient's heart rate. The oximeter may be incorporated or integrated with the pain management device 110. Oxygen and heart rate measurements are recorded and displayed on a controller screen or another peripheral device. It is anticipated that oxygen saturation will be expressed as the percentage of arterial hemoglobin in the oxyhemoglobin configuration. Measurements from the oximeter may also be used to determine what sort of therapies the pain management device 110 should provide at a given time and to assess how effective certain therapies are for increasing oxygen saturation for specific patients. These measurements and responses could be automatically controlled by the system controller 150. Specifications of a commercially available pulse oximeter sensor which can be used with the pain management device 110 are listed in Table 3.

TABLE 3

| | |
|---|---|
| Display mode | LED |
| SPO₂ Measurement | 70-99% |
| range: | |
| SPO₂ Accuracy: | +-2% on the stage of 80%-99%; +-2% on |
| | the stage of 70%-80% |
| Pulse measurement range: | 30-235 BPM |
| Pulse Accuracy: | +-2 BPM or +-2% (larger) |
| Battery consumption: | Two AAA 1.5 V, 600 mAh alkaline batteries |
| | could be continuously used as long as 30 |
| | hours |
| Dimension: | Length: 58 mm Width: 32 mm Height: |
| | 34 mm |
| Operation Temperature: | 5-40 C. |
| Storage Temperature: | −10-40 C. |
| Ambient Temperature: | 15%-80% in operation, 10%-80% in storage |

The electrical components in combination with data obtained from the physiological sensors are used for providing bio-feedback. Bio-feedback is the process of becoming aware of various physiological functions using instruments that provide information on the activity of those same physiological systems. The goal of bio-feedback measurements is to determine which types of physiological functions must be manipulated to obtain certain desired therapeutic results. Types of processes which can be controlled under appropriate conditions include, but are not limited to, brainwaves, muscle tone, skin conductance, heart rate, and pain perception.

Since physiological changes often occur in conjunction with changes of thoughts, emotions, and behavior, such bio-feedback may be used to improve overall health or performance. The pain management device 110 incorporates bio-feedback by integrating pad and/or compression sleeve placement and device function. For example, the device 110 effectively provides electromyography using surface electrodes to detect muscle action potentials from underlying skeletal muscles that initiate muscle contraction. Data is obtained by recording surface electromyogram (SEMG) using one or more electrodes that are placed over a target muscle. A reference electrode is placed within six inches of the active recording electrodes. Comparison of the active and reference electrodes provides bio-feedback related to stress of the target muscle group and, more generally, the stress level of the patient. Bio-feedback may be used when treating anxiety, worry, chronic pain, repetitive stress/strain injuries, essential hypertension, headache, low back pain, physical rehabilitation, tempromandibular joint disorder, torticollis, and fecal incontinence, urinary incontinence, and pelvic pain. Similarly, in another preferred and non-limiting embodiment, the physiological sensors 124 which measure skin temperature (e.g. a thermistor) provide measurements that can be used to estimate arteriole diameter. A thermistor is usually attached to a finger or toe.

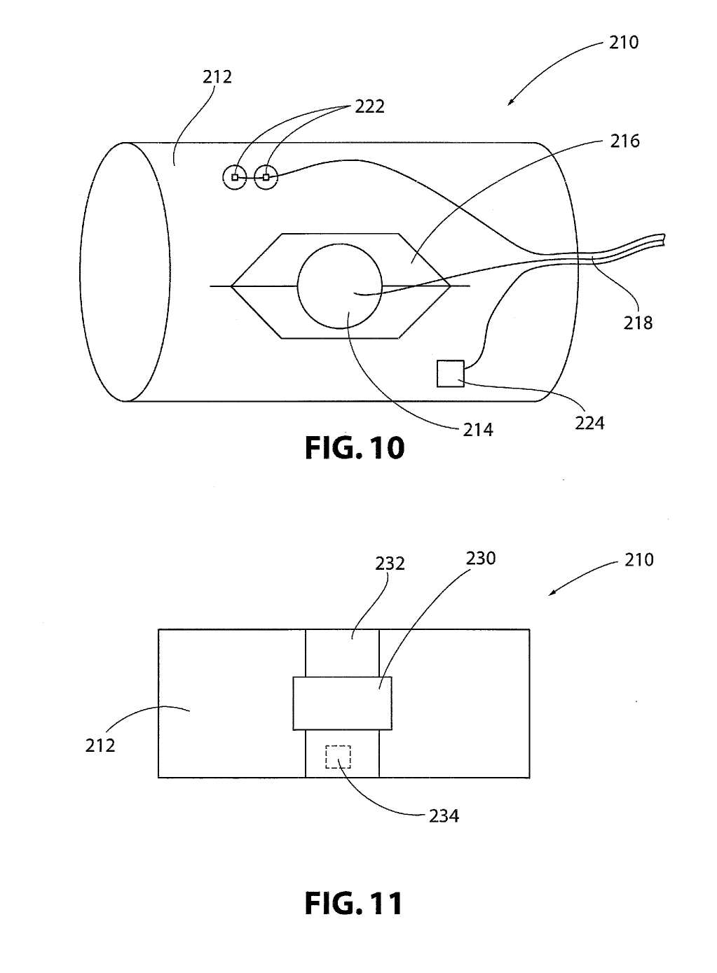

With reference to FIGS. 10 and 11, a further preferred and non-limiting embodiment of a pain management device 210 is depicted, which includes a compression sleeve 212. The compression sleeve 212 may correspond to the base 12 or pad cover 112 of the previously-described embodiments of the invention and is used for affixing the various electrical components of the device 210 to the user. The compression sleeve 212 is made from a high tenacity stretch fabric, such as spandex (elastane), capable of exerting a compressive force against the body. The various electrical components described above for use with the device 210, including the motor 214 and heating (or cooling) element 216, are interwoven within the material tube. The device 210 may also include stimulation electrodes 222 and physiological sensors 224, as discussed above. Compression sleeves 212 of various sizes may be worn in numerous locations on the body (e.g., hand, hand-elbow, hand-elbow-axilla, foot, foot-knee, foot-knee-hip, back, shoulder, abdomen, hip, cervical, thoracic, and lumbar spine).

Compression increases blood circulation by exerting a graduated pressure on the area in contact and has been found to alleviate circulatory problems such as edema, phlebitis, and thrombosis. In certain preferred and non-limiting embodiments, the compression sleeve 212 further includes a linear torque motor 230 enabling the subject/patient to adjust the compressive force of the sleeve 212 as needed. More particularly, the linear torque motor 230 is configured to tighten a band 232 wrapped around the sleeve 212 to increase sleeve compression. Other devices, mechanisms, and configurations for constricting the compression sleeve 212, as are known in the art, can be utilized within the scope and context of the present invention including, but not limited to, pneumatic-based compression/constriction elements (e.g., inflatable sections which when inflated reduce the interior sleeve 212 diameter), automated compression/cinching mechanisms, and/or manual compression/cinching mechanisms. The compressive force of the sleeve 212 can also be measured using pressure sensors 234 and adjusted to a pre-determined value.

Unlike compression stockings which provide a constant compressive force along the length of the stocking, a compression sleeve 212, having a plurality of constricting or compressing components, may be configured to provide a gradient of compressive force along the length of the sleeve 212. For example, a gradient could be created along the length of the sleeve 212 so that compressive force is greatest near the ankle and gradually decreases nearer to the knee. Advantageously, compressing the surface veins, arteries, and muscles, according to this gradient pattern, effectively forces circulating blood through narrower circulatory channels. As a result, the arterial pressure is increased which causes more blood to return to the heart and less blood to pool in the feet.

The compressive sleeve 212 and constriction elements are especially useful for patients who are prone to blood clots and lower limb edema. For these patients, the sleeve 212 can be worn while the patient is ambulatory to assist the proper flow of blood back to the heart or during periods of inactivity (e.g. sitting) to prevent blood from pooling in the legs and feet. Similarly, the compressive sleeve 212 is used by diabetics and/or individuals with chronic peripheral venous insufficiency caused by incompetent perforator veins. According to one embodiment of the invention, the compressive force of the sleeve 212 can be measured using a pressure sensor and then displayed for the user on the attached control unit or recorded for future use. The compressive force (measured in terms of pressure exerted on the extremity by the sleeve 212) may be adjusted using the compression/constriction devices to achieve the desired therapeutic impact.

It is important to note that a patient must have sufficient arterial blood flow to safely wear a compression sleeve. Since patients with reduced blood flow have an increased risk of arterial occlusion, it is important that a patient's arterial blood flow be determined before beginning treatment. To safely use the compression sleeve 212 of the present invention, a patient's Ankle Brachial Index (ABI) must be greater than 1.0 per leg. The ABI indicates how unobstructed a patient's leg and arm arteries are. Any competent doctor or nurse can measure and calculate a patient's ABI. Further, it is crucial that the compression sleeve 212 is properly sized. For example, in a compression sleeve 212 for the lower leg, the compression should gradually reduce from the highest compression at the smallest part of the ankle, until a 70% reduction of pressure just below the knee.

The compression sleeve 212 also addresses and aids in venous and lymphatic drainage of the extremities. The gradient compression of the compression sleeve 212 coupled with linear compression and vibration assists the muscle pump effect in circulating blood and lymph fluid through the extremities in non-ambulatory subjects/patients, permitting nutrients to reach cells faster and more efficiently. It is also recognized that the compression sleeve 212 need not be placed directly or indirectly on the injured area targeted for treatment, such as in the treatment of lymphatic conditions. For example, and as discussed above, compression aids in accelerating the absorption rate of lymphatic fluid and increasing blood vessel permeability. Therefore, strategic placement of the compression sleeve 212 and vibration motor 214 at regions above (i.e. closer to the heart) an injured portion of an extremity such as arms or legs effectively prevents pooling of lymphatic fluid and blood near the injured area.

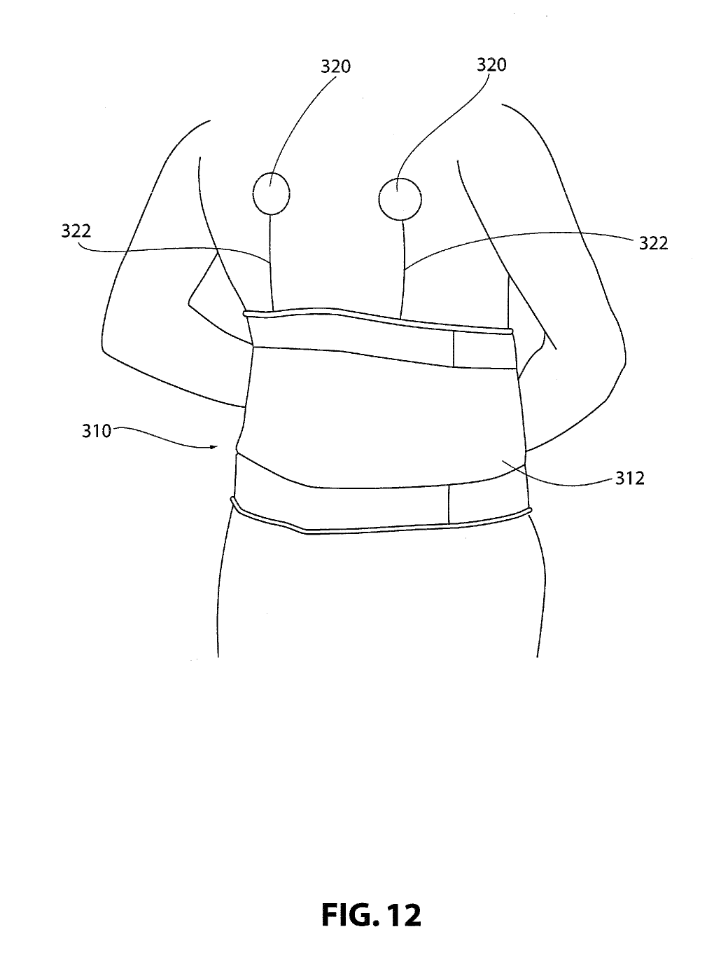

With reference to FIG. 12, and in a further preferred and non-limiting embodiment, additional pads 320 are included which extend from the pain management device 310 for simultaneously treating adjacent areas of the patient's body. As shown in the illustration depicted in FIG. 12, a compression sleeve 312 is wrapped around the lower torso of a patient. Additional pads 320 extend from the compression sleeve 312 and are affixed to the upper back of the user. The pads 320 and compression sleeve 312 are connected by a cable 322. Each pad 320 includes a motor (not shown) for providing targeted vibration therapy to a specific region of the body. The pads 320 may be strategically placed near different body regions which are known to experience pain at the same time. For example, in FIG. 12, both the upper and lower back regions are receiving treatment.

The pad 120, compression sleeve 212, or combined compression sleeve 312 and pad 320 may be placed anywhere on the body to counteract pain and permit wound healing. Specifically, the device and system may be configured to treat of specific muscle groups which are known pain sources. For example, the device may be placed near the Achilles tendon or dorsum (top) of the foot, or on the palm and dorsum of the hand to treat generalized pain, muscular weakness, radiculopathy, median nerve, and/or dermatomal pain patterns. Regions along the anterior and posterior of the lower extremities also benefit from the target vibration and electrical stimulation therapies provided by the device. However, suggested pad placements are only intended for general reference as locations with muscle groups or individual muscles which often benefit from treatments provided by the pain management device. It is understood that the device may also placed in other locations for treatment of other muscles or muscle groups depending on the needs of individual patients. Additionally, pad placement is somewhat subjective and may be based on what the patient feels at any given time. Advantageously, the patient can easily move the pads or compression sleeve to painful areas to receive instant treatment. Depending on the intensity of treatment and size of the pad or compressive sleeve, the device may be used to strengthen a generalized weakness of an entire muscle group or to provide more direct treatment to a specific muscle. Vibration may be utilized to diminish pain and/or help aid in bone growth.

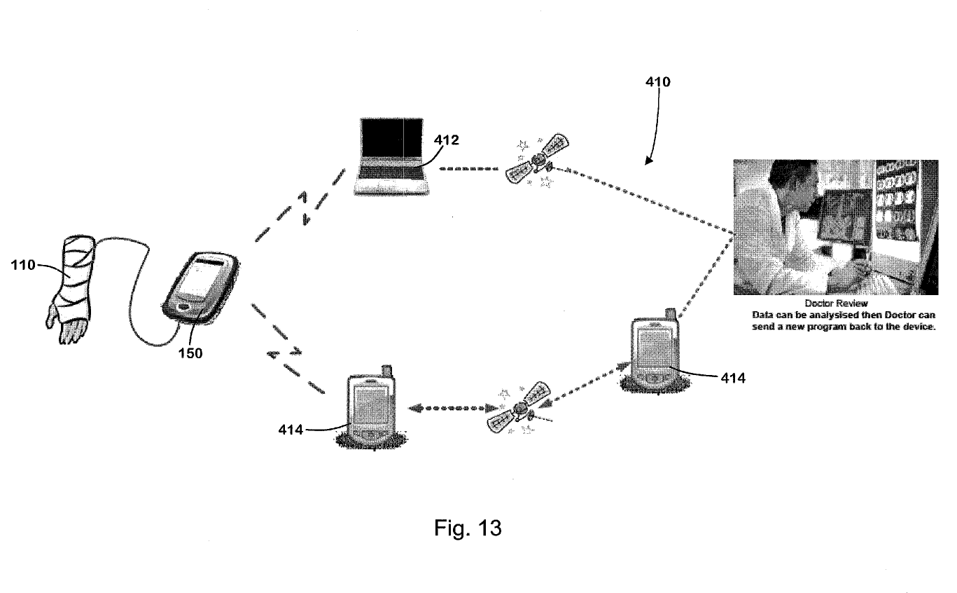

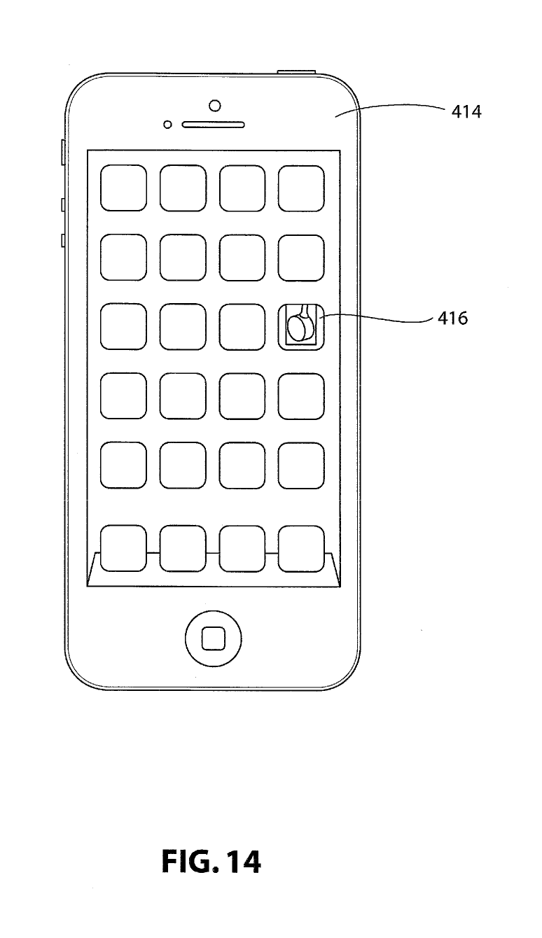

With reference to FIGS. 13-15, having described various embodiments for the wearable portion of the pain management device 110, 210, 310, including the various electric components that can be included therewith, a system 410 for transferring data between the controller unit 150 of the device and external sources, devices, and people will now by discussed. As described more fully above, the electrical components may include: a vibrating motor, e-stim pad, heating element, compression mechanism, physiological sensors, blower motor, oxygen sensors, body temperature sensors, and other operable or measurement components. The various controllable or monitoring components may be connected to the controller unit 150 through wired 118 or wireless connections. In one preferred and non-limiting embodiment, the controller unit 150 functions as a microprocessor controlling, managing, and/or monitoring the functions of the sensors and electrical components of the device and system. The controller unit 150 also is adapted to receive input from a user and to modify the function of the device 110, as necessary, based on input from a patient or practitioner. In one preferred and non-limiting embodiment, the controller unit 150 further includes a user interface for displaying data to the user, such as the pressure exerted on the body by the compression sleeve 212, 312 and heart rate/oxygen saturation values as measured by the oximeter.

The connection between the device 110, controller unit 150, and external devices creates, in effect, a personal area network (PAN) comprising the device, a data transmitter and an external receiver attached to an external source. A PAN is a computer network used for communication (e.g., data transmission) among computer devices including telephones and personal digital assistants (PDAs) in close proximity to the user's body. PANs can be used for communication among the personal devices themselves (intrapersonal communication), or for connecting to a higher level network and the Internet (an uplink). Networks may be wired, using, e.g., USB, Ethernet, and FireWire protocols. A wireless personal area network (WPAN) is made possible with wireless network technologies such as Bluetooth, WiFi, Z-Wave, and ZigBee. WiFi (e.g., IEEE 802.11(a), (b), (g), (n)) networking protocols may be used, which advantageously have a greater transmission range than Bluetooth, but consequently also have greater power consumption. Suitable external sources for receiving and processing data transmitted from the device 110 and controller unit 150 include a computer, tablet PC, smart phone, and/or an external hard drive or other device for backing up stored data. In one embodiment of the system 410, the controller unit 150 is adapted to connect with a docking bay (not shown). The docking bay acts as a saddle for the controller 150 enabling the device to recharge and facilitating a connection through USB, radio frequency, and/or Bluetooth to send data to one or more external devices.

With continued reference to FIGS. 13-15, in one preferred and non-limiting embodiment of the system 410, data is uploaded to a computer 412. The computer 412 analyzes the data using a software program which formulates a personal medical record for the patient based on the type and duration of treatment provided and measured physiological changes as a result of the treatment. Using the measured or determined data, a practitioner and/or the patient can determine which treatments are especially effective and better assess future treatment options.

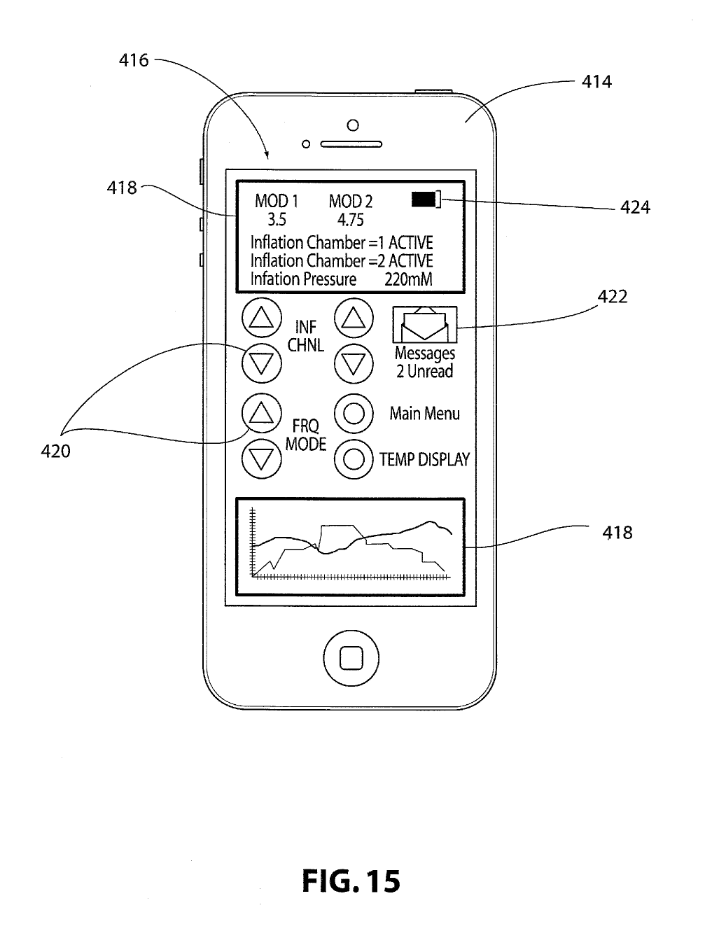

Alternatively, data is uploaded to a smart phone 414 running a phone application program (the “App”). The App collects data and sends instructions to the controller 150. An icon for accessing the application is depicted in the schematic drawing depicted in FIG. 15. As shown in FIG. 15, the App includes a graphical user interface (GUI) 416 for displaying received data and for sending instructions to the controller 150. For example, the GUI may include an information section 418 which provides information about the various treatments being performed including the intensity and duration of electrical stimulation and vibration treatments. The information section may also include additional information including the compression pressure of the compressible sleeve (if present), as well as readings from the physiological sensors. The physiological sensor readings may be presented as numerical values or, in some embodiments, as a continuously updated graph showing change in the physiological state of the user over time. The information section 418 may also include operating information such as a battery level indicator 424 showing the battery charge level. Any information obtained by, transmitted within, or determined by the device, controller, or system may be displayed on the GUI 416.

The GUI 416 may also include navigation features 420 allowing the user to control the various treatment functions using the smart phone. For example, the user can increase or decrease treatment intensity, turn “on” or “off” various types of treatment, or run pre-determined treatment sequences from the smart phone. The GUI 416 may also include a communication function such as an integrated messaging system 422 for sending information to and from doctors, therapists, family members, or caregivers. For example, the communication system may be configured to send a message to a user's doctor when a prescribed treatment regiment is completed. A doctor may also send information directly to the patient's phone including information about what types of treatments should be performed, duration, frequency, etc. If necessary, the smart phone 414 may be connected to a computer 412 through a higher level network (e.g. the Internet) for further data processing. For example, the computer 412 could be used to provide detailed reports about a patient's treatment record. The reports may include data about the changes in physiological condition of the patient over time, based on readings from the physiological sensors. The computer 412 may also be configured to analyze physiological data to draw conclusions about whether specific types of treatment are effective for a specific patient. The computer 412 may also compare treatment data from multiple patients to draw conclusions about whether a patient's response to various treatments is normal, more responsive, or less responsive. The analysis and reports can be used by doctors, practitioners, or caregivers to improve future treatments.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A vibration device for providing a vibration sensation to a user, the device comprising:
a base;
a vibrating element;
a power source; and
an actuation mechanism configured to facilitate an electrical connection between the power source and vibrating element, thereby causing the vibrating element to vibrate.

2. The device of claim 1, further comprising a printed circuit board connected to the vibrating element and power source, the printed circuit board including a circuit for selectively establishing the electrical connection between the vibrating element and the power source.

3. The device of claim 2, wherein the vibrating element and power source are disposed on a top surface of the printed circuit board, and wherein the base is disposed below the printed circuit board.

4. The device of claim 2, wherein the power source is positioned above the printed circuit board, and the vibrating element is positioned below the printed circuit board.

5. The device of claim 1, wherein at least a portion of the base comprises a cushioned pad.

6. The device of claim 5, wherein at least a portion of the base further comprises an adhesive arrangement configured to affix the vibration device to the skin of the user.

7. The device of claim 1, wherein at least a portion of the base comprises a therapeutic agent capable of diffusing through the skin of a user.

8. The device of claim 1, wherein the actuation mechanism further comprises member slidably disposed between the vibrating element and the power source, wherein moving the member establishes an electrical connection between the power source and the vibrating element.

9. The device of claim 1, wherein the actuation mechanism further comprises at least one of the following: an on/off button, an on/off timer, a pulsing mechanism, a vibration intensity modifier, or any combination thereof.

10. The device of claim 1, wherein the power source comprises at least one of the following: a battery, a disposable battery, a rechargeable battery, or any combination thereof.

11. The device of claim 9, further comprising a clip at least partially surrounding the battery, the clip comprising at least one prong for contacting a terminal of the battery, and at least one leg in electrical connection with the vibrating element for establishing the electrical connection between the battery and vibrating element through the clip.

12. A system for providing a vibrating sensation to a user for pain management, comprising:
a base;
a vibrating element; and
a controller in electrical communication with at least one of the base and the vibrating element.

13. The system of claim 12, further comprising at least one electrode configured to contact the skin of a user for providing electrical stimulation to the user, wherein the at least one electrode is configured to provide at least one of the following therapies: neuromuscular electrical stimulation (NMES), microcurrent electrical neuromuscular stimulator (MENS), electrical muscle stimulation (EMS), transcutaneous electrical nerve stimulation (TENS), iontophoresis, or any combination thereof.

14. The system of claim 13, wherein the base comprises an existing stimulation electrode pad and wherein the vibrating element is inserted within or affixed to the pad.

15. The system of claim 12, further comprising at least one physiological sensor for monitoring the physical condition of the user.

16. The system of claim 12, further comprising a thermal element configured to provide a hot or cold sensation to the user.

17. The system of claim 13, further comprising a therapeutic agent to be delivered to a user by iontophoresis, wherein the vibrating element is configured to provide vibration to substantially interrupt pain receptors of a user during iontophoresis.

18. The system of claim 12, wherein at least a portion of the base comprises a compression sleeve configured to provide compression at at least a portion of the sleeve.

19. The system of claim 18, wherein the compression sleeve comprises at least one constricting element configured to increase or decrease the constricting force of the sleeve.

20. The system of claim 18, wherein the compression sleeve comprises at least one constricting element configured to provide a compression gradient along at least a portion of the sleeve

21. The system of claim 18, wherein the compression sleeve comprises at least one of the following: a pneumatic-based compression element, a pneumatic-based constriction element, an automatic compression element, an automatic cinching element, a manual compression element, a manual cinching element, or any combination thereof.

22. The system of claim 12, wherein the controller is configured to at least one of receive, process, and transmit data representative of at least one parameter of at least one component of the system.

23. The system of claim 12, further comprising an external data transfer system, the data transfer system comprising:
a data transmitter for establishing a wired or wireless connection and transmitting data between the controller and at least one data analysis device, the data comprising at least one of the following: operating data, physiological data, or any combination thereof,
wherein the at least one data analysis device includes a microprocessor for processing the data received from the data transmitter.

24. The system of claim 23, wherein the microprocessor of the at least one data analysis device determines at least one physiological effects of a treatments used on the user based at least partially upon data from at least one physiological sensor.

25. A method of manufacturing a vibration device for providing a vibrating sensation to a user, the device comprising:
providing a substrate layer,
forming at least one printed circuit board on the substrate layer, the at least one printed circuit board including embedded circuitry for establishing an electrical connection between electrical components;
affixing a vibrating element to the at least one printed circuit board; and
connecting an actuation mechanism between a power source and the vibrating element, the actuation mechanism configured to selectively establish an electrical connection between the vibrating element and the power source to form the vibrating device.

26. The method of claim 25, wherein a plurality of vibrations are formed by:
forming a plurality of printed circuit boards on the substrate layer;
dividing the substrate layer to form a plurality of individual printed circuit boards;
affixing a vibrating element to each printed circuit board; and
connecting an actuation mechanism between a power source and each vibrating element of each printed circuit board.

27. The method of claim 25, further comprising the step of inserting the vibrating element in an existing stimulation electrode pad or affixing the vibrating element to an existing stimulation electrode pad.
